(19) United States
(12) Patent Application Publication
(10) Pub. No.: US 2022/0381577 A1
(43) Pub. Date: Dec. 1, 2022

(54) DIRECTIONAL GUIDANCE FOR A SPACE

(71) Applicant: HARMAN INTERNATIONAL INDUSTRIES, INCORPORATED, Stamford, CT (US)

(72) Inventors: Kevin HAGUE, San Jose, CA (US); Daniel Timothy PYE, Los Angeles, CA (US)

(21) Appl. No.: 17/335,519

(22) Filed: Jun. 1, 2021

(51) Int. Cl. G01C 21/36; G01C 21/34

(52) U.S. Cl. CPC G01C 21/3641; G01C 21/3476; G01C 21/3415; G01C 21/3629; G01C 21/3652

(57) ABSTRACT

Embodiments of the present disclosure set forth techniques for directional guidance for a space. A computer-implemented method for guiding a user through a space includes determining a current location of the user and a destination location, where the current location and the destination location are locations within the space; determining a path from the current location to the destination location; determining at least one guidance cue associated with the path; and causing at least one guidance output device along the path to output the at least one guidance cue, wherein the at least one guidance output device is installed in the space.

### BACKGROUND

### Field of the Various Embodiments

The various embodiments relate generally to navigation systems, and more specifically, to directional guidance for a space.

### Description of the Related Art

Large spaces and campuses are a common sight in modern life. These large spaces can have one or more buildings or structures, which themselves can be quite large, and/or one or more large open spaces. Well-known examples of such large spaces include an office campus, an airport, a transit station or terminal, an office building, a hospital complex, a university campus, a shopping mall, a stadium, a vacation resort, a theme park, and/or the like. Due to the sizes and/or complexities of these large spaces, navigating and travelling to a specific location within these spaces can be challenging for both visitors and regulars alike.

Large spaces typically include directory information on-site to provide navigational guidance to users of those spaces. The on-site directory information is typically presented in a physical and static form (e.g., a directory plaque, a directory kiosk), and typically includes a directory of locations and/or a map. A drawback of this approach to providing navigational guidance is that the user is left on his or her own to find, and to determine a path to, a desired location using the directory information. Further, the user is left on his or her own to remember and recall, and navigate through, that path when travelling to the desired location. The on-site directory information can be scaled down to a printed directory and/or map that the user can carry, but that also has similar drawbacks as those described above and has the additional drawback of incurring paper waste. Alternatively, the user can take a photo of the static directory and/or map with a personal device, but this also has similar drawbacks as those described above.

A response to the above drawbacks is a computerized directory kiosk that provides on-site directory information. A computerized directory kiosk can enable a user to search for a desired location by name or category. The computerized directory kiosk determines a path from the location of the kiosk to the desired location and displays that path on a map to the user. A drawback of this approach is that the user is still left on his or her own to remember and recall that path when travelling to the desired location. As with the above, the user can take a photo of the displayed map and path with a personal device, but this also has similar drawbacks as those described above.

Another response to the above drawbacks is the use of a navigation application on a personal device (e.g., a smartphone). A navigational data database, which can be local to the device or remotely served from a server or cloud system, can include information on specific locations within the space, including a layout, directory, and/or the like. The navigation application operates on the personal device in conjunction with the navigational data database and a satellite-based navigation system (e.g., Global Positioning System (GPS), GALILEO, BeiDou, GLONASS, etc.) to guide the user to a desired location within the space. Alternatively, the navigation application can operate in conjunction with the navigational data database and local wireless networks (e.g., Wi-Fi, beacons, Bluetooth Low-Energy devices). A drawback of this approach is that the navigational data database may not have the data for the specific space in which the user is interested. Another drawback of this approach is that the reliance on a satellite-based navigation system or local wireless networks makes this approach unreliable. For example, radio signals for communicating with the satellite-based navigation system can be greatly attenuated while indoors, making navigation using the navigation application more difficult. A further drawback of this approach, as well as the other approaches and responses, described above, is that the location information for the space, in any of the forms described above, is static and incapable of providing navigation information regarding a moving destination (e.g., a person).

What is needed are more effective navigation systems for large spaces.

### SUMMARY

One embodiment sets forth a computer-implemented method comprising determining a current location of a user and a destination location, where the current location and the destination location are locations within the space; determining a path from the current location to the destination location; determining at least one guidance cue associated with the path; and causing at least one guidance output device along and/or proximate to the path to output the at least one guidance cue, where the at least one guidance output device is installed in the space.

Further embodiments provide, among other things, one or more non-transitory computer-readable media and systems configured to implement the method set forth above.

At least one technical advantage of the disclosed techniques relative to the prior art is that directional guidance can be provided to a user of a space dynamically without reliance on personal devices, a satellite navigation system, and/or printed information. Accordingly, any user of the space can receive directional guidance for navigating within the space without being left to navigate on their own with or without a personal device and/or printed information. Further, a user of the space can receive directional guidance for navigating within the space without the unreliability of using a satellite navigation system while indoors. Another advantage is that the disclosed embodiments can provide guidance to navigate to a specific person or object associated with the space, who may be moving around within the space. A further advantage is that the disclosed embodiments can guide a user to a location associated with the user based on timely information associated with the user (e.g., an upcoming event at a location in the space). Yet another advantage is that the disclosed embodiments can be used to navigate people to the nearest exit or safe zone during an emergency and/or to guide emergency and/or other response personnel to the location of a fire and/or other emergency or incident. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a space directional guidance system, according to various embodiments;

FIG. 2 illustrates operation of a space directional guidance application included in the space directional guidance system of FIG. 1, according to various embodiments;

FIG. 3 illustrates an example of a guidance cue for navigating a space, according to various embodiments; and

FIG. 4 illustrates a flow diagram of method steps for providing guidance cues for navigating a space, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

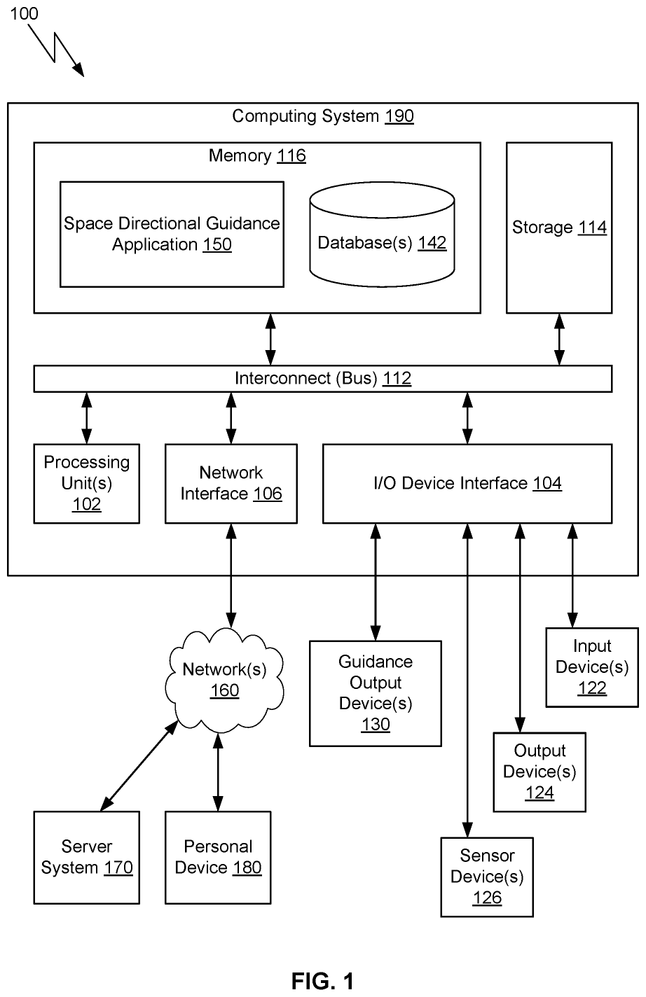

FIG. 1 illustrates a block diagram of a space directional guidance system 100, according to various embodiments. As shown, space directional guidance system 100 (hereinafter “guidance system 100”) includes, without limitation, computing system 190, one or more sensor devices 126, input device(s) 122, output device(s) 124, guidance output device(s) 130, and network 160. Guidance system 100 optionally further includes server system 170 and/or personal device 180. Computing system 190 includes one or more processing units 102, I/O device interface 104, network interface 106, interconnect (bus) 112, storage 114, and memory 116. Memory 116 stores database(s) 142 and space directional guidance application 150 (hereinafter “guidance application 150”). Processing unit(s) 102, I/O device interface 104, network interface 106, storage 114, and memory 116 can be communicatively coupled to each other via interconnect 112.

Guidance system 100 includes one or more components that are implemented at a space (e.g., a university campus, an office campus, etc.). For example, guidance output device(s) 130, input device(s) 122, output device(s) 124, and sensor device(s) 126 could installed at various locations in the space. Computing system 190 could be implemented at the space and communicatively coupled with guidance output devices 130, input device(s) 122, output device(s) 124, and sensor device(s) 126 installed at the space. Additionally or alternatively, computing system 190 could be located remotely from the space and communicatively coupled with guidance output devices 130, input device(s) 122, output device(s) 124, and sensor device(s) 126 installed at the space.

As noted above, computing system 190 can include processing unit(s) 102 and memory 116. Computing system 190 can include a system-on-a-chip (SoC). In various embodiments, computing system 190 may be a single computing device or a system composed of multiple computing devices (e.g., a distributed computing system). Computing system 190 can be a networked system, a server system, a cloud computing system, and/or the like. Generally, computing system 190 can be configured to coordinate the overall operation of guidance system 100. The embodiments disclosed herein contemplate any technically feasible system configured to implement the functionality of guidance system 100 via computing system 190.

Processing unit(s) 102 can include a central processing unit (CPU), a digital signal processing unit (DSP), a microprocessor, an application-specific integrated circuit (ASIC), a neural processing unit (NPU), a graphics processing unit (GPU), a field-programmable gate array (FPGA), and/or the like. Each processing unit 102 generally comprises a programmable processor that executes program instructions. In some embodiments, processing unit(s) 102 may include any number of processing cores, memories, and other modules for facilitating program execution. In some embodiments, processing unit(s) 102 can be configured to execute guidance application 150 to provide guidance services, as described below.

Storage 114 can include non-volatile storage for applications, software modules, and data, and can include fixed or removable disk drives, flash memory devices, and CD-ROM, DVD-ROM, Blu-Ray, HD-DVD, or other magnetic, optical, solid state storage devices, and/or the like. For example, guidance application 150 and database(s) 142 could be stored in storage 114, and then loaded into memory 116 as needed.

Memory 116 can include a memory module or collection of memory modules. Memory 116 generally comprises storage chips such as random access memory (RANI) chips that store application programs and data for processing by processing unit(s) 102. Processing unit(s) 102, I/O device interface 104, and network interface 106 can be configured to read data from and write data to memory 116. Guidance application 150 can be loaded from storage 114 into memory 116. While in memory 116, guidance application 150 can be executed by processing unit(s) 102 to implement the functionality described in the present disclosure.

Database(s) 142 can store values and other data retrieved or computed by processing unit(s) 102 to coordinate the operation of guidance application 150. Database(s) 142 may be stored in storage 114 and loaded into memory 116 as needed. In various embodiments, processing unit(s) 102 may be configured to retrieve data and/or information stored in database(s) 142. In some embodiments, database(s) 142 can store navigation data or information for a space (e.g., maps of the space including maps of outdoor spaces and indoor spaces, locations of landmarks in the space, directory of landmarks, etc.), and optionally user information (e.g., user identification information, users' calendar entries, etc.) and/or other information associated with the space (e.g., reservations of rooms in the space, calendar of events taking place in the space, etc.). In some embodiments, database(s) 142 may receive periodic updates for at least a portion of the data stored in database(s) 142 (e.g., updates to maps and directory) from a remote computing system (e.g., server system 170, a cloud computing system) via network interface 106 and network 160 or from manual user input (e.g., via a computing device that provides a user interface for data input into database(s) 142).

Sensor device(s) 126 includes one or more sensor devices that generate and/or acquire data from an environment of the space. In various embodiments, sensor device(s) 126 can generate sensor data associated with a user of the space. For example, sensor device(s) 126 can capture one or more images of the user in the space and/or receive data from an identity document or token (e.g., a radio frequency identification (RFID) or near field communication (NFC) enabled identity badge or keycard) associated with the user and/or a mobile device of the user. Sensor device(s) 126 can include one or more imaging sensors, one or more radio receivers, and/or one or more NFC readers. In various embodiments, sensor device(s) 126 are installed at various locations in the space and are communicatively coupled to computing system 190. For example, each building in the space could have a number of imaging sensors, radio receivers, NFC readers, etc. distributed throughout the building, and similar devices can be installed throughout the outdoor areas of the space as well. Other examples of sensor device(s) 126 can include beacon device readers or receivers and other sensors configured to acquire and/or generate sensor data regarding user identity, user location in the space, and/or user presence. In some embodiments, sensor device(s) 126 are communicatively coupled to computing system 190 and send sensor data to processing unit(s) 102. Processing unit(s) 102 can execute guidance application 150 in order to process sensor data received from sensor devices 126 to recognize and/or locate the user as the user moves around in the space and/or determine an identity of the user based on the sensor data.

In various embodiments, examples of imaging sensors include, without limitation, RGB cameras, infrared cameras, depth cameras, and/or camera arrays, which include two or more of such cameras. Other examples of imaging sensors include imagers, laser sensors, ultrasound sensors, radar sensors, and/or LIDAR sensors. The imaging sensors can include a network of imaging sensors (e.g., a closed-circuit camera system, a set of network-enabled cameras) installed throughout the space.

Input device(s) 122 includes devices capable of receiving input, such as a keyboard, a mouse, a touch-sensitive screen, a microphone, and/or the like for receiving input data and providing the input data to computing system 190. Other examples of input device(s) 122 can include a single-purpose input device (e.g., a button) implemented at the space for predefined use cases. For example, a single button for finding the nearest restroom can be implemented at the space, and a user can press the single button to get guidance to the nearest restroom. Output device(s) 124 includes devices capable of providing output, such as one or more display devices, one or more speakers, and/or the like for outputting data (e.g., content) from computing system 190. Examples of display devices include, without limitation, LCD displays, LED displays, touch-sensitive screens, and/or the like. Additionally, input devices 122 and output devices 124 may include devices capable of receiving input and/or output (e.g., a touch-sensitive display).

Input device(s) 122 and/or output device(s) 124 can be external to computing system 190 and interface with computing system 190 via I/O device interface 104. In various embodiments, input devices 122 and output devices 124 are installed at various locations in the space and are communicatively coupled to computing system 190. For example, each building in the space could have an interactive directory kiosk, where the directory kiosk is a computing terminal or computing device communicatively coupled to computing system 190 and that includes one or more input device(s) 122 and one or more output device(s) 124. In various embodiments, guidance application 150 can determine and/or identify a destination location associated with a user based on inputs received by one or more input devices 122 (e.g., the user types in, selects, or speaks a specific location via an input device 122). In various embodiments, guidance application 150 can output information to the user (e.g., a map of the space, a directory of the space, location information associated with the space, user interface prompts, etc.) via one or more output devices 124.

Guidance output device(s) 130 can output various human-perceivable guidance cues to guide a user through the space. Guidance output device(s) 130 can output guidance cues in various forms, including visual, auditory, and/or haptic forms. Guidance output device(s) 130 can output a guidance cue into the air or onto a surface (e.g., onto the floor, onto a wall), depending on the particular form of the guidance cue. Guidance output device(s) 130 can include any technically feasible device for outputting such human-perceivable cues, including but not limited to projector devices (e.g., an image projector, a laser projector), indicator lights and/or arrays thereof (e.g., light-emitting diode (LED) arrays embedded on or lining a floor or a wall), a directional audio speaker, and/or a haptic device (e.g., a mid-air haptic device, a floor vibration device). In various embodiments, guidance output device(s) 130 can be controlled by computing system 190 via control signals generated by computing system 190 and transmitted to guidance output device(s) 130. Guidance output device(s) 130 can be installed at various locations in the space and are communicatively coupled to computing system 190.

Network(s) 160 may enable communications between computing system 190 and other devices in network via wired and/or wireless communications protocols, satellite networks, telephone networks, ad hoc networks and short-range networks, including Bluetooth, Bluetooth low energy (BLE), wireless local area network (Wi-Fi), cellular protocols, and/or near-field communications (NFC). Network(s) 160 can be any technically feasible type of communications network that allows data to be exchanged between computing system 190 and remote systems or devices, such as a server system 170, a cloud computing system, cloud-based storage, or other networked computing device or system. For example, network(s) 160 could include a wide area network (WAN), a local area network (LAN), a wireless network (e.g., a Wi-Fi network, a cellular data network), and/or the Internet, among others. Computing system 190 can connect with network(s) 160 via network interface 106. In some embodiments, network interface 106 is hardware, software, or a combination of hardware and software, that is configured to connect to and interface with network(s) 160. In various embodiments, computing system 190 can communicate with a server system 170 and/or a personal device 180 via network(s) 160. For example, a server system 170 (e.g., a cloud computing system, etc.) can host various information that can be acquired and processed to determine and/or identify a destination location associated with a user, and computing system 190 can connect to that sever system 170 via a local network and/or the Internet to acquire the information hosted at the server system 170.

In some embodiments, a personal device 180 can communicate with computing system 190 via network(s) 160. For example, computing system 190 can provide a user interface (e.g., a web page) that personal device 180 can access. Via personal device 180 accessing the user interface via network 160 (in particular, a LAN or Wi-Fi network local to and associated with the space), a user can input a destination location and/or a user identity into computing system 190. Also via the user interface, computing system 190 can display information (e.g., location information associated with the space, a directory, a map, etc.) to the user. Thus, personal device 180 can serve as an additional input device 122 or output device 124 for receiving input and/or provide output. In some embodiments, personal device 180 can also include sensor devices similar to sensor devices 126 (e.g., imaging sensors), from which computing system 190 can obtain sensor data (e.g., images of the user, tag data associated with the user). Personal device 180 can be any technically feasible computing device, such as a laptop computer, a desktop computer, a smartphone, a tablet computer, a smart watch, smart glasses, smart headphones, headset, or other wearable device, and/or the like.

As described above, sensor devices 126, input devices 122, output devices 124, and/or guidance output devices 130 can be distributed and installed at various locations throughout the space. Accordingly, such devices can be distributed throughout the space at various distances from computing system 190. In various embodiments, guidance system 100 further includes, in addition or alternatively to I/O device interface 104, one or more intervening networks and/or intermediate devices for interfacing with the above devices 126, 122, 124, and/or 130. The intervening network(s) can be a network amongst network(s) 160. The intermediate devices can be signal routing devices, signal relay devices, device controllers, and/or the like for relaying communications and data between computing system 190 and devices 126, 122, 124, and/or 130. Further, in some embodiments, devices 126, 122, 124, and/or 130 can be network-enabled devices and can interface with computing system 190 via networks 160, in additional to or in lieu of I/O device interface 104. For example, devices 126, 122, 124, and/or 130 could be “Internet of things” (IoT) devices that interface with computing system 1909 via network(s) 160. Further, in some embodiments, one or more of devices 126 and/or 130 can be combined into a unit for installation. For example, a sensor device 126 (e.g., a camera) can be integrated with a guidance output device 130 (e.g., a projector device) into a combined unit that can be installed outdoors (e.g., mounted on a light post or wall) or indoors (e.g., mounted on a wall or ceiling).

In a large space, such as an office campus, university campus, hospital campus, and/or the like, a user typically navigates through the space to a destination location in the space by finding a destination location using on-site, static information, and then navigating a path to the destination location. A drawback of this approach is that the user is left on his or her own to remember and/or navigate through the path. While some navigation applications on personal devices can provide information on specific locations in large spaces, such navigation applications often do not have location information for every possible large space the user may encounter. Further, such navigation applications rely on satellite navigation systems, and navigation based on satellite-based systems are unreliable when the user is indoors within the large space.

To address these and other drawbacks, guidance system 100 can provide guidance cues to a user, to help the user navigate through the space. In guidance system 100, which is implemented at the space, guidance application 150 executing on computing system 190 can identify a destination location associated with a user, determine a path to the destination location, and control the one or more guidance output devices 130 to output guidance cues along the path to the user. This approach addresses the above-described drawbacks, and further enables navigation to a dynamic location within the space (e.g., a moving person or object).

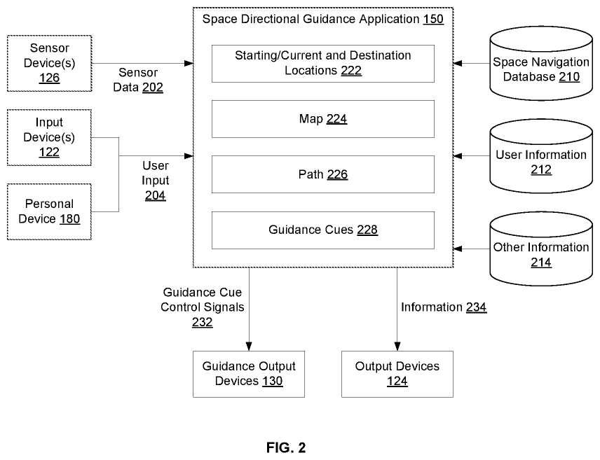

FIG. 2 illustrates operation of a space directional guidance application included in the space directional guidance system of FIG. 1, according to various embodiments. In operation, guidance application 150 can control one or more guidance output devices 130 to provide guidance cues to a user in a navigation environment (e.g., a large space as described above). In various embodiments, guidance application 150 executes on a computing system 190 associated with the navigation environment. For ease of understanding, operation of guidance application 150 is described below using an example of a guidance system 100 implemented at a navigation environment that is a university campus, but the operation of guidance application 150 is equally applicable to other navigation environments.

In operation, guidance application 150 in the navigation environment can obtain user input 204 from an input device 122 located in the navigation environment and/or a personal device 180. For example, the university campus can have multiple directory kiosks distributed throughout the campus (e.g., one per on-campus building, various ones installed at outdoor locations on the campus), and each directory kiosk can include one or more input devices 122 and one or more output devices 124. A user at the campus (e.g., a visitor, a student or employee looking for an unfamiliar on-campus location) can access a user interface via output device(s) 124 and input a destination location using input device(s) 122 (e.g., speak the location, type in the location, search for the location from a directory). In some embodiments, the user can also input other information from which a destination location can be determined, such as an event that is taking or will take place on the campus, or a specific entity associated with the campus (e.g., a staff or faculty member on the campus, a mobile food cart, a group that meets regularly on campus). Additionally or alternatively, the user can access a user interface (e.g., a web page, a mobile app) of computing system 190 via personal device 180 to input the information. Additionally or alternatively, the user can activate a single-purpose input device implemented at the space. Guidance application 150 can determine an approximate current location of the user based on the known location of the kiosk where the user input the information using input device 122, or a location of the network access point, associated with network(s) 160, via which the user accessed the user interface using personal device 180. Accordingly, user input 204 can include input made via input device 122 and/or personal device 180. In some embodiments, locations of input devices 122, sensor devices 126, and/or network access points are associated with locations of respective landmarks, waypoints, and/or the like in the navigation environment.

Guidance application 150 can also obtain sensor data 202 associated with the user via sensor device(s) 126. In some embodiments, sensor data 202 can include image data and/or tag data. Guidance application 150 can obtain image data from imaging sensors. In particular, guidance application 150 can obtain image data from captured images of the user throughout the space. The image data can be obtained from an imaging sensor at the kiosk, if the kiosk includes an imaging sensor, imaging sensors in proximity of the single-purpose input device, and/or from imaging sensors installed throughout the campus (e.g., security cameras installed throughout the campus). Guidance application 150 can further read an RFID or NFC tag via sensor device(s) 126 to obtain tag data from the tag. For example, sensor devices 126 could include a receiver or reader that reads an identity and/or visitor badge of the user (e.g., the user swipes his or her badge at the kiosk equipped with a receiver/reader, receivers/readers installed throughout the campus can detect the badge as the user walks about the campus) and obtain tag data from the badge. Guidance application 150 can determine an approximate current location of the user based on the known location of the sensor device 126 (e.g., imaging sensor, receiver/reader) where the sensor data was obtained (e.g., known location of kiosk where an image of the user was captured and/or where the user swiped his badge). In some embodiments, guidance application 150 can also access a sensor device on personal device 180 (e.g., a camera and/or an NFC reader on personal device 180) to obtain sensor data 202 associated with the user (e.g., capture image data of the user and/or read the user's badge).

In some embodiments, sensor data 202 further includes sensor data associated with other entities in the navigation environment besides the user. For example, sensor data 202 could include image data of other persons and/or objects on campus, and/or tag data read from tags associated with those other persons or objects.

Based on user input 204 and/or sensor data 202, guidance application 150 can determine the identity of the user (e.g., correlate the image data and/or tag data with a database of campus personnel), determine whether the user has ties to the campus (e.g., user is a student, employee, or other campus-associated personnel) or is a visitor, and/or recognize the user sufficiently to differentiate him or her from other users as the user walks about without specifically identifying the user. In some embodiments, guidance application 150 can perform face and/or object recognition on images and/or perform voice recognition on a voice input of the user to identify and/or recognize the user. In some embodiments, guidance application 150 can, via imaging sensors, scan a code (e.g., a barcode, a QR code) printed on identity documentation (e.g., an identity card or badge, a visitor card or badge) and identify the user based on the scanned code. Also, as noted above, guidance application 150 can also determine an approximate current location of the user based on sensor data 202 and/or user input 204, correlated with a known location of the sensor device 126 and/or input device 122 where sensor data 202 and/or user input is obtained, and/or a known location of the network access point where personal device 180 accessed the user interface of computing system 190. In some embodiments, based on user input 204 and/or sensor data 202, guidance application 150 can determine a destination location. For example, user input 204 could explicitly specify a destination location. As another example, user input 204 could select an event or entity in which the user is interested, and guidance application 150 can determine, in conjunction with space navigation database 210, user information 212, and/or other information 214 described below, a destination location associated with the event (e.g., a location of the event) or entity (e.g., a current or last known location of the entity on the campus). As a further example, guidance application 150 could identify the user based on sensor data 202 and, in conjunction with space navigation database 210, user information 212, and/or other information 214 described below, determine that the user has an upcoming event or room reservation (e.g., the user is a host or invitee for the event or reservation, the user has the event or reservation in his or her calendar) and determine the location of the event or room reservation as the destination location.

Guidance application 150 can obtain various information from database(s) 142. The information obtained from database(s) 142 can include information from a space navigation database 210, user information 212, and other information 214. Space navigation database 210 includes information regarding locations in the navigation environment (e.g., locations of specific landmarks, waypoints, rooms, halls, buildings, stores, and/or the like), one or more maps of the navigation environment, a directory of the navigation environment, locations of onsite input devices 122, output devices 124, sensor devices 126, guidance output devices 130, and network access points associated with network(s) 160, and any other suitable location information associated with the navigation environment. In some embodiments, space navigation database 210 represents the information stored therein as at least a graph of nodes and edges (e.g., locations as nodes; hallways, walkways, and other paths as edges).

User information 212 includes information associated with users that have ties to the navigation environment. For example, user information 212 can include a database of campus personnel (e.g., staff, faculty, students, registered visitors or guests) with identifying information (e.g., tag identifier, images, voice samples), calendar entries in personal calendars of the campus personnel, and/or the like. Other information 214 can include other information associated with the navigation environment. Examples of other information 214 include, without limitation, on-campus room reservations, on-campus public events calendar, on-campus groups information, schedules and locations of maintenance vehicles and/or equipment, schedules of patrol vehicles, schedules and locations of food carts and trucks regularly doing business on the campus, and/or the like. In some embodiments, space navigation database 210, user information 212, and/or other information 214 can be obtained from server system 170.

In some embodiments, guidance application 150 can output information from space navigation database 210, user information 212, and/or other information 214 to the user via a user interface accessed from a kiosk as described above and/or from personal device 180. For example, guidance application 150 could output, on a display device of output device(s) 124, any of a map and directory of the navigation environment, an indication of an identity of the user as determined by guidance application 150 (so that the user can confirm or reject the determination), an onsite event calendar (e.g., so that the user can select a desired event), a calendar event and/or room reservation associated with the user (e.g., so that the user can confirm the event and/or reservation as indicative of the destination location), and so on. In some embodiments, space navigation database 210, user information 212, and/or other information 214 can include information that are marked as public or private, or otherwise include access and use limitations. For example, guidance application 150 can limit access to and use of information marked as private to users associated with the private information (e.g., access to a private calendar entry is limited to the owner of the entry, access to a room reservation can be limited to the host and invitees). As another example, information can be marked as restricted to visitors but otherwise open to campus personnel. Accordingly, guidance application 150 can restrict access to and use of information if the user is a visitor with no ties to the campus (e.g., guidance application 150 will hide private events and room reservations from a user identified as a visitor).

Guidance application 150, with the obtained data, input, and/or information described above, can determine and/or generate starting and destination locations 222, a map 224, a path 226, and one or more guidance cues 228. Starting (and/or current) and destination locations 222 include a starting location (and/or current location of the user) for navigation and a destination location for navigation. The starting location can be a current location of the user in the navigation environment, determined based on sensor data 202 and/or user input 204, correlated with known locations of landmarks, waypoints, input devices 122, sensor devices 126, network access points, and/or the like, as described above. Locations of landmarks, waypoints, input devices 122, sensor devices 126, network access points, etc. can be stored in, and obtained from, space navigation database 210. In some embodiments, guidance application 150 can periodically determine and update the current location of the user using similar techniques (e.g., via sensor data 202) as described above for determining the initial current location of the user and determine the updated current location as a new starting location.

The destination location is a location in the navigation environment to which the user wishes to go within the navigation environment, as determined by guidance application 150. The destination location can be determined from user input 204, sensor data 202, space navigation database 210, user information 212, and/or other information 214, as described above. In some embodiments, the destination location can be static or dynamic. Static destination locations include, for example, a room, a building, a landmark, and/or the like. A preset destination location can be associated with a single-purpose input device (e.g., the nearest restroom). A dynamic destination location can include any on-campus entity that can move around in the navigation environment, such as a specific person associated with the campus (e.g., a staff member, a faculty member, a student) or a mobile object (e.g., a mobile food cart, a maintenance vehicle, a patrol vehicle). If the destination location is a dynamic destination location (e.g., user input 204 indicates a specific person or object as the destination), guidance application 150 can periodically determine (e.g., track) the current location of the dynamic destination location using sensor data 202 in conjunction with space navigation database 210, user information 212, and/or other information 214. In various embodiments, guidance application 150 can track a dynamic destination location, in particular an object or a person, if the object or person is opted into location tracking for purposes of services provided by guidance application 150. If the person or object is not opted into or is opted out, then guidance application 150 can return an error message to the user (e.g., a “person/object cannot be located” message, a “person does not wish to disclose his location” message) or determine a static destination location associated with the person or object (e.g., an employee's assigned office room on the campus based on directory information, a location of a mobile food cart based on a predefined schedule). In some embodiments, guidance application 150 can track the object or person based on fencing rules (e.g., rules or boundaries stored in user information 212 or other information 214). If the object or person is removed from the area designated in a fencing rule associated with the object or person, guidance application 150 can alert administrators of the space.

Guidance application 150 can determine and/or generate a map 224 (e.g., a portion of one or more maps of the navigation environment that are relevant to the user, based on starting and destination locations 222). Map 224 can be obtained from space navigation database 210.

Guidance application 150 can determine and/or generate a path 226 for travelling from the starting location to the destination location. Guidance application 150 can determine the path using any technically feasible technique applied to data obtained from space navigation database 210 (e.g., graph analysis algorithms if space navigation database 210 represents locations and paths as a graph of nodes and edges). For example, guidance application 150 can place starting and destination locations 222 as nodes within the graph and perform a shortest path or other algorithm analysis on the graph to determine a path.

Guidance application 150 can determine and/or generate one or more guidance cues 228 to be output along path 226. Guidance cues 228 can be output along the path 226 to guide the user from the starting location to the destination location. Guidance cues 228 can be visual, auditory, and/or haptic cues that cue the user on the path the user should travel on to get to the destination location. For example, guidance cues 228 can include cues to go straight ahead, to follow along a walkway, to turn a corner, to go up or down stairs, to turn left or right into a room, to take an elevator or escalator, to enter or exit a building, and/or the like. Guidance cues 228 can be output by guidance output devices 130 proximate to points along path 226. Guidance cues 228 can be determined based on path 226 and locations of guidance output devices 130 (obtained from space navigation database 210) along path 226. Guidance application 150 can further generate guidance cue control signals 232 that control guidance output devices 130 to output the determined guidance cues 228 at the proper time based on the current location of the user. In some embodiments, guidance application 150 can determine guidance cues 228 that are relevant to the current location of the user. Instead of determining guidance cues 228 for the entire path 226 all at once, guidance application 150 can determine guidance cues 228 for a portion of path 226 based on the current location of the user (e.g., a portion of the path that is proximate to the current location of the user). Accordingly, guidance application 150 can determine guidance cues 228, and generate corresponding control signals 232, for each portion of path 226 based on the current location of the user.

In some embodiments, guidance cues 228 can have different output parameters based on the particular user for which the cues are determined. For example, guidance cues 228 can be output with different colors for different users that are in proximity and for which guidance cues are being provided. Other examples of different output parameters include using different shapes, different visual frequencies (e.g., a flashing or animation frequency for visual cues), different output sounds and/or voices (for auditory cues), different directions of audio output for auditory cues output via directional audio speakers), different audio repetition frequencies (e.g., a tone repetition frequency, a frequency for repeating a speech cue), different haptic frequencies (for haptic cues), and/or the like. These output parameters can be included in, or otherwise reflected in, guidance cue control signals 232.

Guidance application 150 can output information 234 to the user via output device(s) 124 and optionally via personal device 180. Information 234 can include a graphical display (e.g., visualization) of starting and destination locations 222, map 224, and path 226. Information 234 thus can serve to provide the user a preview of path 226 before the user starts travelling along path 226.

Guidance application 150 transmits guidance cue control signals 232 to one or more guidance output devices 130 based on the current location of the user. Guidance application 150 can determine and/or update the current location of the user and transmit a control signal 232 to a guidance output device 130 proximate to the current location of the user. The transmitted control signal 232 controls that guidance output device 130 to output a guidance cue 228 appropriate to the current location of the user. As the user travels along path 226, guidance application 150 can determine the current location of the user and transmit the pertinent guidance cue control signal 232 to a pertinent guidance output device 130. Guidance cue control signals 232 can include commands to turn on or off a guidance cue, timing for turning on or off, parameters for the guidance cue (e.g., color, haptic frequency, etc.), and/or the like.

As noted above, guidance application 150 can determine and/or update the current location of the user and/or a dynamic destination location. Based on an updated current location of the user and/or an updated dynamic destination location, guidance application 150 can update starting and/or destination locations 222, map 224, path 226, guidance cues 228, guidance cue control signals 232, and/or information 234. When guidance application 150 determines that the user has arrived at the destination location (e.g., the current location of the user matches the destination location within a predefined tolerance range), guidance application 150 can cease the location updating describe above and cease providing guidance cues 228 to the user (e.g., cease transmitting control signals 232 to guidance output devices 130).

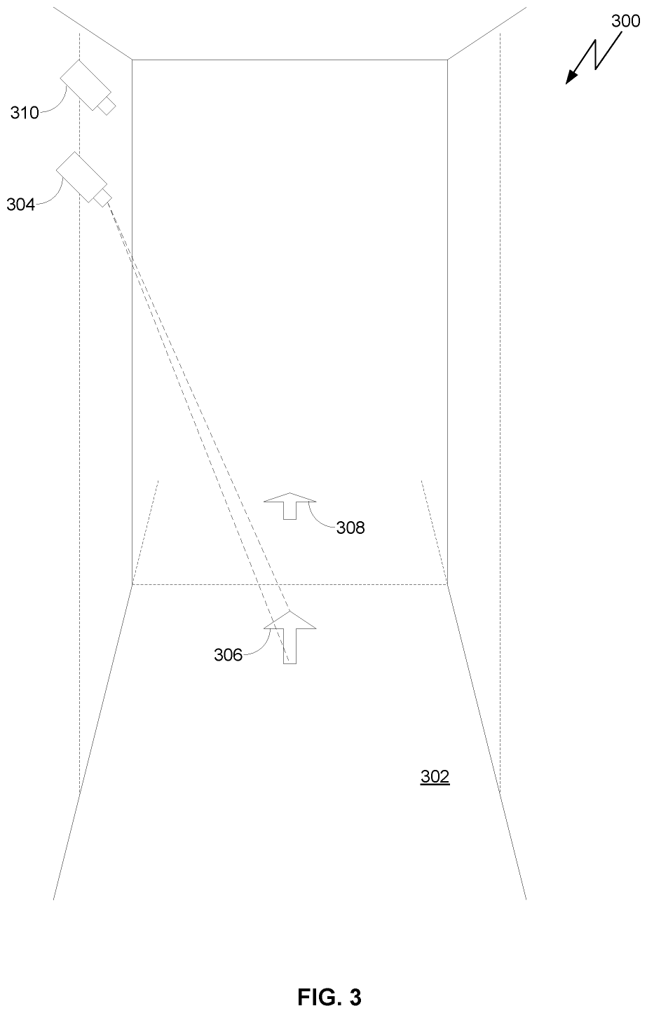

FIG. 3 illustrates an example of a guidance cue for navigating a space, according to various embodiments. As shown from a first-person perspective of a user (not shown in FIG. 3), a hallway 300 (e.g., a hallway in a building in a navigation environment), includes a floor 302. One or more guidance output devices 130 (e.g., projector device 304) and one or more sensor devices 126 (e.g., camera 310) are installed along hallway 300. As the user walks along hallway 300, guidance application 150 can detect the current location of the user via sensor devices 126 (e.g., images captured via camera 310). Based on the detected current location of the user, guidance application 150 can transmit a guidance cue control signal 232 to projector device 304. Guidance cue control signal 232 controls projector device 304 to project a cue arrow 306 onto floor 302, when the user is in proximity based on the detected current location of the user. Cue arrow 306, as seen by the user from the first-person perspective shown in FIG. 3, cues the user to continue walking straight ahead along hallway 300. Projector device 304 and/or another projector device installed along hallway 300 can also project another cue arrow 308 onto floor 302 as the user walks further along hallway 300. Projector device 304 and/or the another projector device can project cue arrows 306 and 308 as a stream of arrows that can be seen by the user, for example to further emphasize the cue to walk straight ahead.

While FIG. 3 describes cue arrows 306 and 308 as output by projector devices, similar visual guidance cues can be output using other types of guidance output devices 130 and/or on surfaces in hallway 300 other than floor 302. For example, similar arrow cues as arrows 306 and 308 could be output using LED lights embedded in floor 302. As another example, arrows 306 and 308 can be projected onto a wall along hallway 300 instead of on floor 302.

In some embodiments, cue arrows 306 and/or 308, and other visual cues, may be replaced and/or supplemented by auditory and/or haptic cues, which can also be output by guidance output devices 130 along hallway 300 based on control signals 232. For example, a mid-air haptic device can output a haptic sensation to the user to cue the user to walk straight ahead. As another example, a floor vibration device could cause vibrations on floor 302 to direct the user to walk straight ahead. As a further example, a directional audio speaker can output an auditory cue to the user or to the ears of the user thereof, without disturbing other persons in proximity. The auditory cue can include tones and/or speech giving the user directional cues (e.g., telling the user to walk straight ahead, indicating a distance remaining before making a turn).

In some embodiments, guidance application 150 can provide guidance in an emergency situation (e.g., a fire, an explosion, a bomb threat, an on-site medical emergency, and/or other natural or manmade emergency situation). Guidance application 150 can provide guidance cues to guide people in the space with evacuation (e.g., guide evacuees to emergency exits and/or to safe zones), and/or to guide emergency and/or other response personnel to the location of a fire and/or other emergency or incident. For example, when fire alarms at the space are activated in response to a fire at the space, guidance application 150 could generate guidance cues to direct evacuees to the nearest emergency exit(s) and/or safe zone(s) for evacuation. Similarly, guidance application 150 could identify the location of the fire and generate guidance cues to guide emergency and/or other response personnel to the site of the fire.

In some embodiments, guidance application 150 can track the actual path taken by a user through the space in response to the guidance cues, including any user deviations and associated re-routing by guidance application 150. The actual paths by multiple users can be logged and stored in a database (e.g., in database 142) for later manual or automatic analysis. Guidance application 150 can use the analysis to optimize its determination of paths 226 to destination locations.

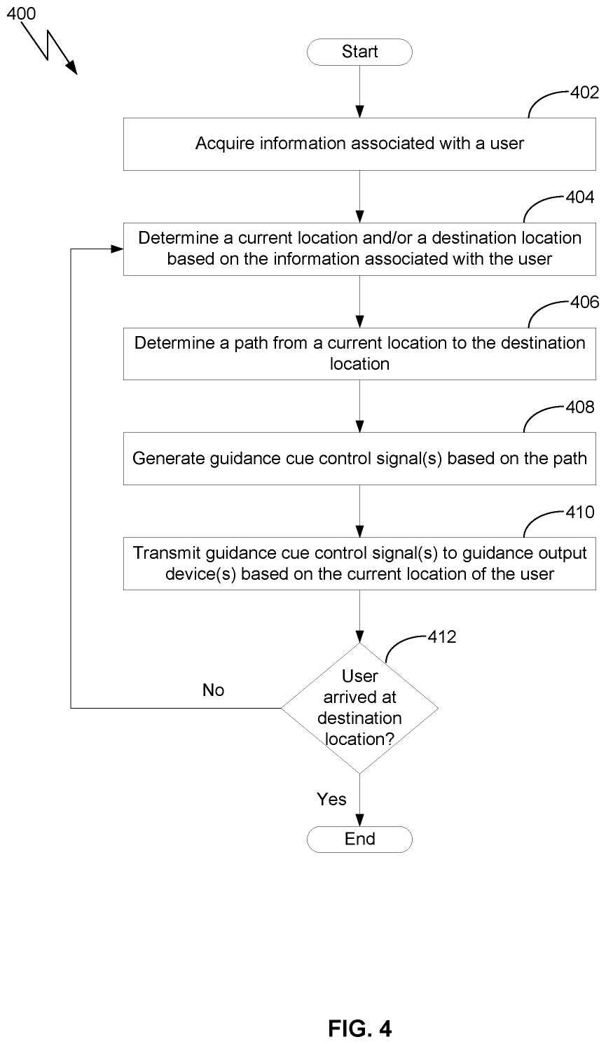

FIG. 4 illustrates a flow diagram of method steps for providing guidance cues for navigating a space, according to various embodiments. Although the method steps are described with respect to the systems of FIGS. 1-3, persons skilled in the art will understand that any system configured to perform the method steps, in any order, falls within the scope of the various embodiments.

As shown, a method 400 begins at step 402, where guidance application 150 acquires information associated with a user. Guidance application 150 can obtain user input 204 input by the user (e.g., a specific destination location, an event or group or person selected or input by the user) and/or sensor data 202 associated with the user (e.g., images of the user, tag data read from a badge of the user). Guidance application 150 can optionally identify the user based on user input 204 (e.g., recognize and identify the user based on voice recognition) and/or sensor data 202 (e.g., recognize and identify the user based on face recognition, reading an identity badge of the user). Guidance application 150 can further obtain user information 212 (e.g., user calendar entries) and/or other information 214 (e.g., room reservations made by the user, information about a meeting the user wishes to attend, public events) that are public and/or are associated with the user.

At step 404, guidance application 150 determines and/or updates a current location and/or a destination location based on the information associated with the user. Guidance application 150 can use the information acquired in step 402 to determine current and/or destination locations 222. Guidance application 150 can determine and/or update a current location of the user (e.g., an initial current location of the user) based on user input 204 and/or sensor data 202. Guidance application 150 can use the current location of the user as a starting location for an initial or updated path 226. Guidance application 150 can also determine and/or update a destination location based on user input 204 and/or sensor data 202, in conjunction with space navigation database 210, user information 212, and/or other information 214. In some embodiments, guidance application 150 can determine a dynamic destination location based on sensor data 202 associated with an entity corresponding to the dynamic destination location (e.g., a person in the space, a mobile object in the space). Guidance application 150 can also determine locations of one or more guidance output devices 130 that are in proximity to the current location of the user.

At step 406, guidance application 150 determines a path from the current location to the destination location. Guidance application 150, in conjunction with information from space navigation database 210, can determine a path 226. For example, guidance application 150 can perform a shortest path analysis or any other technically feasible technique to determine and/or update a path 226 between current and destination locations 222.

At step 408, guidance application 150 generates guidance cue control signal(s) based on the path. Based on path 226 and locations of guidance output devices 130 along path 226, guidance application 150 can determine one or more guidance cues 228, and further generate corresponding guidance cue control signals 232 for controlling guidance output devices 130 to output guidance cues 228. In some embodiments, guidance application 150 determines guidance cues 228, and generates corresponding control signals 232, based on the current location of the user (e.g., guidance cues 228 relevant to the portion of path 226 where the user is currently located). In some embodiments, guidance application 150 generates guidance cue control signal(s) from the current location until a next anticipated waypoint on the path (e.g., the next sensor device 126, the next doorway to be entered or exited through, the next landmark).

At step 410, guidance application 150 transmits one or more guidance cue control signals 232 to one or more guidance output devices 130 based on the current location of the user determined in step 404. Guidance application 150 transmits control signals 232 corresponding to guidance cues 228 appropriate for the current location of the user along path 226 to one or more guidance output devices 130 in proximity of the current location of the user. Those guidance output devices 130 are configured to output one or more guidance cues 228 to the user according to those control signals 232.

At step 412, guidance application 150 determines whether the user has arrived at the destination location. For example, guidance application 150 can determine whether the current location of the user, as determined in step 404, matches the destination location within a tolerance range (e.g., a predefined radius around the destination location). If the user is determined to have arrived at the destination location, then method 400 ends (412—Yes). If the user is determined to have not arrived yet at the destination location, then method 400 proceeds (412—No) back to step 404.

In sum, a directional guidance system implemented at a space can provide guidance to users of the space. The system includes guidance output devices, implemented at the space, that can output guidance cues to a user to guide the user to a specific location in the space. A space directional guidance application of the system receives an input indicating a destination location and/or person within the space (e.g., user input of a location or a person in and associated with the space, user data indicating an upcoming event at a location and/or with a person in and associated with the space). The guidance application can retrieve the user data based on recognition of the user via one or more sensors and/or input devices (e.g., face recognition, voice recognition, an identity badge, a scanned code). The guidance application can determine a navigation path (e.g., a walking path) through the space to the desired location and/or person. The guidance application can control the guidance output devices to output guidance cues to direct the user along the navigation path toward the destination.

At least one technical advantage of the disclosed techniques relative to the prior art is that directional guidance can be provided to a user of a space dynamically without reliance on personal devices, a satellite navigation system, and/or printed information. Accordingly, any user of the space can receive directional guidance for navigating within the space without being left to navigate on their own with or without a personal device and/or printed information. Further, a user of the space can receive directional guidance for navigating within the space without the unreliability of using a satellite navigation system while indoors. Another advantage is that the disclosed embodiments can provide guidance to navigate to a specific person or object associated with the space, who may be moving around within the space. A further advantage is that the disclosed embodiments can guide a user to a location associated with the user based on timely information associated with the user (e.g., an upcoming event at a location in the space). Yet another advantage is that the disclosed embodiments can be used to navigate people to the nearest exit or safe zone during an emergency and/or to guide emergency and/or other response personnel to the location of a fire and/or other emergency or incident. These technical advantages provide one or more technological advancements over prior art approaches.

1. In some embodiments, a computer-implemented method for guiding a user through a space comprises determining a current location of the user and a destination location, wherein the current location and the destination location are locations within the space; determining a path from the current location to the destination location; determining at least one guidance cue associated with the path; and causing at least one guidance output device along the path to output the at least one guidance cue, wherein the at least one guidance output device is installed in the space.

2. The method of clause 1, wherein the at least one guidance cue directs the user from the current location toward the destination location.

3. The method of clauses 1 or 2, wherein determining the current location comprises determining the current location based on user input, wherein the current location is associated with a location where the user input is made.

4. The method of any of clauses 1-3, wherein determining the current location comprises determining the current location based on sensor data, wherein the current location is associated with a location where the sensor data is captured.

5. The method of any of clauses 1-4, wherein determining the destination location comprises determining the destination location based on user input indicating at least one of an event, a group, a person, or an object, wherein the destination location corresponds to a location in the space associated with the at least one of the event, the group, the person, or the object.

6. The method of any of clauses 1-5, wherein determining the destination location comprises identifying the user; and determining the destination location based on information associated with the identified user.

7. The method of any of clauses 1-6, wherein the information associated with the identified user comprises at least one of a calendar event or a reservation associated with the identified user.

8. The method of any of clauses 1-7, wherein causing the at least one guidance output device along the path to output the at least one guidance cue comprises causing the at least one guidance output device when the current location of the user is proximate to the at least one guidance output device.

9. The method of any of clauses 1-8, further comprising updating at least one of the current location or the destination location; updating the path based the at least one of the updated current location or the updated destination location; determining at least one second guidance cue associated with the updated path; and causing at least one guidance output device along the updated path to output the at least one second guidance cue.

10. The method of any of clauses 1-9, wherein the at least one guidance cue comprises at least one of a visual cue, an auditory cue, or a haptic cue.

11. In some embodiments, a system comprises a guidance output device installed in a space; a memory storing an application; and one or more processors that, when executing the application, is configured to determine a current location of a user and a destination location, wherein the current location and the destination location are locations within the space; determine a path from the current location to the destination location; determine a guidance cue associated with the path; and cause the guidance output device to output the guidance cue, wherein the guidance output device is proximate to the path.

12. The system of clause 11, wherein the guidance cue comprises at least one of a visual cue, an auditory cue, or a haptic cue.

13. The system of clauses 11 or 12, wherein the guidance output device comprises at least one of a projection device, an LED array, an audio speaker, or a mid-air haptic device.

14. The system of any of clauses 11-13, further comprising one or more imaging sensors, and wherein the one or more processors, when executing the application, are further configured to capturing one or more images of the user using the one or more imaging sensors; and determining the current location of the user based on a location where the one or more images are captured.

15. The system of any of clauses 11-14, wherein the one or more processors, when executing the application, are further configured to identify the user based on the one or more images of the user.

16. The system of any of clauses 11-15, further comprising one or more tag readers, and wherein the one or more processors, when executing the application, are further configured to read tag data associated with the user using the one or more tag readers; and determining the current location of the user based on a location where the tag data is read.

17. The system of any of clauses 11-16, wherein the one or more processors, when executing the application, are further configured to identify the user based on the tag data.

18. The system of any of clauses 11-17, wherein the destination location is a dynamic destination location corresponding to a moving person or object, and determining the path from the current location to the destination location comprises determining a path to the moving person or object.

19. In some embodiments, one or more non-transitory computer-readable storage media include instructions that, when executed by one or more processors, cause the one or more processors to perform the steps of determining a current location of a user in a space; determining a destination location in the space; determining a path from the current location of the user to the destination location; determining at least one guidance cue associated with the path; and causing at least one guidance output device along the path to output the at least one guidance cue.

20. The one or more non-transitory computer-readable storage media of clause 19, wherein causing at least one guidance output device along the path to output the at least one guidance cue comprises generating one or more control signals associated with at least one of a visual cue, an auditory cue, or a haptic cue; and transmitting the one or more control signals to the at least one guidance output device.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for guiding a user through a space, comprising:
determining a current location of the user and a destination location, wherein the current location and the destination location are locations within the space;
determining a path from the current location to the destination location;
determining at least one guidance cue associated with the path; and
causing at least one guidance output device along the path to output the at least one guidance cue, wherein the at least one guidance output device is installed in the space.

2. The method of claim 1, wherein the at least one guidance cue directs the user from the current location toward the destination location.

3. The method of claim 1, wherein determining the current location comprises determining the current location based on user input, wherein the current location is associated with a location where the user input is made.

4. The method of claim 1, wherein determining the current location comprises determining the current location based on sensor data, wherein the current location is associated with a location where the sensor data is captured.

5. The method of claim 1, wherein determining the destination location comprises determining the destination location based on user input indicating at least one of an event, a group, a person, or an object, wherein the destination location corresponds to a location in the space associated with the at least one of the event, the group, the person, or the object.

6. The method of claim 1, wherein determining the destination location comprises:
identifying the user; and
determining the destination location based on information associated with the identified user.

7. The method of claim 6, wherein the information associated with the identified user comprises at least one of a calendar event or a reservation associated with the identified user.

8. The method of claim 1, wherein causing the at least one guidance output device along the path to output the at least one guidance cue comprises causing the at least one guidance output device when the current location of the user is proximate to the at least one guidance output device.

9. The method of claim 1, further comprising:
updating at least one of the current location or the destination location;
updating the path based the at least one of the updated current location or the updated destination location;
determining at least one second guidance cue associated with the updated path; and
causing at least one guidance output device along the updated path to output the at least one second guidance cue.

10. The method of claim 1, wherein the at least one guidance cue comprises at least one of a visual cue, an auditory cue, or a haptic cue.

11. A system, comprising:
a guidance output device installed in a space;
a memory storing an application; and
one or more processors that, when executing the application, is configured to:
determine a current location of a user and a destination location, wherein the current location and the destination location are locations within the space;
determine a path from the current location to the destination location;
determine a guidance cue associated with the path; and
cause the guidance output device to output the guidance cue, wherein the guidance output device is proximate to the path.

12. The system of claim 11, wherein the guidance cue comprises at least one of a visual cue, an auditory cue, or a haptic cue.

13. The system of claim 11, wherein the guidance output device comprises at least one of a projection device, an LED array, an audio speaker, or a mid-air haptic device.

14. The system of claim 11, further comprising one or more imaging sensors, and wherein the one or more processors, when executing the application, are further configured to:
capturing one or more images of the user using the one or more imaging sensors; and
determining the current location of the user based on a location where the one or more images are captured.

15. The system of claim 14, wherein the one or more processors, when executing the application, are further configured to identify the user based on the one or more images of the user.

16. The system of claim 11, further comprising one or more tag readers, and wherein the one or more processors, when executing the application, are further configured to:
read tag data associated with the user using the one or more tag readers; and
determining the current location of the user based on a location where the tag data is read.

17. The system of claim 16, wherein the one or more processors, when executing the application, are further configured to identify the user based on the tag data.

18. The system of claim 11, wherein the destination location is a dynamic destination location corresponding to a moving person or object, and determining the path from the current location to the destination location comprises determining a path to the moving person or object.

19. One or more non-transitory computer-readable storage media including instructions that, when executed by one or more processors, cause the one or more processors to perform the steps of:
determining a current location of a user in a space;
determining a destination location in the space;
determining a path from the current location of the user to the destination location;
determining at least one guidance cue associated with the path; and
causing at least one guidance output device along the path to output the at least one guidance cue.

20. The one or more non-transitory computer-readable storage media of claim 19, wherein causing at least one guidance output device along the path to output the at least one guidance cue comprises:
generating one or more control signals associated with at least one of a visual cue, an auditory cue, or a haptic cue; and
transmitting the one or more control signals to the at least one guidance output device.
